(19) United States
(12) Patent Application Publication
(10) Pub. No.: US 2026/0135744 A1
(43) Pub. Date: May 14, 2026

(54) KAN-BASED AUTOENCODER WITH SYMBOLIC REGRESSION FOR ENERGY-EFFICIENT CHANNEL CODING

(71) Applicant: UNIVERSITY OF SOUTH CAROLINA, COLUMBIA, SC (US)

(72) Inventors: ANTHONY PERRE, COLUMBIA, SC (US); ALPHAN SAHIN, COLUMBIA, SC (US)

(21) Appl. No.: 19/385,549

(22) Filed: Nov. 11, 2025

Related U.S. Application Data
(60) Provisional application No. 63/720,435, filed on Nov. 14, 2024.
(60) Provisional application No. 63/804,053, filed on May 12, 2025.

(51) Int. Cl. H04L 27/26; G06N 3/0455; G06N 3/048; G06N 3/082

(52) U.S. Cl. CPC H04L 27/2601; G06N 3/0455; G06N 3/048; G06N 3/082

(57) ABSTRACT

Apparatus and methodology are disclosed for Kolmogorov-Arnold network (KAN)-based autoencoders (AEs) with symbolic regression (SR) for orthogonal frequency-division multiplexing (OFDM) to achieve energy-efficient channel coding. A KAN-based AE can provide comparable performance to a multi-layer perceptron (MLP)-based AE in terms of block-error rate (BLER) while providing superior energy efficiency along with SR. SR is used to convert KANs into symbolic expressions. A non-linearity score is used in the SR process to obtain equations leading to low-complexity implementation and improved energy efficiency at the radios. To assess energy efficiencies of the MLP and KAN models, we compute the presently disclosed non-linearity score for both models, which is determined to be 6.84648×10⁵ and 1.2366×10⁶ for the KAN-based AE and the MLP-based AE, respectively. KANs are a viable alternative to MLPs for machine-learning based channel coding because the MLP-based model consumes 1.38 times more energy than the SR model.

### PRIORITY CLAIM

The present application claims the benefit of priority of U.S. Provisional Patent Application No. 63/720,435, filed Nov. 14, 2024, titled Online Training of KAN Autoencoder for Energy Efficient Channel Coding, and the benefit of priority of U.S. Provisional Patent Application No. 63/804,053, filed May 12, 2025, titled KAN-Based Autoencoder With Symbolic Regression For Energy-Efficient Channel Coding, and both of which are fully incorporated herein by reference for all purposes.

### BACKGROUND OF THE PRESENTLY DISCLOSED SUBJECT MATTER

### I. Introduction

Mobile devices face significant limitations in computational power, memory, and battery life; consequently, traditional neural networks are difficult to implement efficiently.

Deep learning (DL) has been successfully demonstrated to replace or improve well-engineered signal processing blocks in the field of wireless communications. For example, it is used for enhancing channel estimation and accurate modulation recognition in [1], [2]. In [3], [4], the end-to-end OFDM communication systems and joint source/channel coding tasks can be learned by using DL techniques. Although DL models show great promise within the field of wireless communications to perform non-trivial tasks, they still see limited practical use in modern communication systems due to several obstacles. Among these issues, one of the biggest issues is mobile device hardware; specifically, the constrained memory resources and CPU capabilities of mobile devices limit the applicability of larger DL models at the radios [5]. Complex models with hundreds of thousands of learnable parameters cause both memory and timing issues for mobile devices [6], which in turn leads to increased energy and power consumption.

Currently, in the DL field, MLPs serve as a foundational building block in many architectures. However, in the past several months, a novel DL structure, called KANs, has emerged as an alternative to MLPs [7]. The authors in [7] claim that KANs can outperform MLPs in terms of accuracy with fewer total parameters. Another study in [8] disputes many of the claims made in [7] regarding the advantages of KANs over MLPs; however, the authors of [8] show that KANs do outperform MLP in terms of symbolic formula representation under a fair comparison. Recently, KANs have seen extensive use in various domains such as physics [9] and time series prediction [10], particularly for their increased interpretability and symbolic representation capabilities.

In this disclosure, we discuss the use of AEs for channel coding, which is discussed in prior works such as [3], [4], [11], [12]. In our approach, we replace MLPs in AE structure with KANs. Once the KAN model is trained, we use SR to derive equations representing the learned network behavior. Additionally, we introduce a non-linearity score term into the SR process to encourage simpler equations where possible. Our use of SR with the presently disclosed non-linearity score term aims to lower energy consumption during model inference. By using KANs, we aim to show that it is possible to reduce the energy usage of certain DL models while maintaining their performance, which suggests that KANs could be an appropriate alternative to MLPs for specific DL tasks within wireless communications.

Organization: This disclosure is organized as follows. Section II presents the system model and provides fundamental concepts regarding KANs. Section III describes the presently disclosed KAN-based AE and discusses the metrics used to assess energy efficiency. Section IV shows the BLER performance and compares the energy efficiency of each model. Section V concludes the specification.

Notation: The expected value of a random variable X is represented as [symbol] [X] The conjugate of a complex number h is written as h*. The set of real numbers is represented by [symbol] . The set of complex numbers is represented by [symbol] . Symmetric complex normal distribution with zero mean and variance σ² is written as CN(0, σ²). The Hermitian of a matrix A is denoted by A^{H}.

### SUMMARY OF THE PRESENTLY DISCLOSED SUBJECT MATTER

The presently disclosed system and corresponding and/or associated methodology relate to energy efficient Kolmogorov-Arnold Network (KAN) autoencoder subject matter with symbolic regression. For instance, a continuous exchange of information between the transmitter and receiver to support adaptation to changing channel conditions is described; specifically, the transmitter and receiver convey information related to the current epsilon value for the non-linearity score, as well as the pruning threshold used at the transmitter and receiver. The feedback between transmitter and receiver may both aid in pruning redundant activation functions and simplify expressions where possible, thereby improving efficiency while preserving performance.

The present disclosure introduces a method for improving communication between devices by using a new machine learning technique. The system allows a transmitter and receiver to adapt to difficult conditions based on feedback from each other. Based on this information, the transmitter and receiver can be simplified in a way that is more energy efficient and maintains performance. In essence, some of the described methods can help to make communication between wireless devices more energy efficient if conditions allow it. The presently described method can be used to improve wireless networks in terms of energy efficiency. The present disclosure may be better understood with reference to the examples, set forth below.

Apparatus and methodology are disclosed for Kolmogorov-Arnold network (KAN)-based autoencoders (AEs) with symbolic regression (SR) for orthogonal frequency-division multiplexing (OFDM) to achieve energy-efficient channel coding. A KAN-based AE can provide comparable performance to a multi-layer perceptron (MLP)-based AE in terms of block-error rate (BLER) while providing superior energy efficiency along with SR. SR is used to convert KANs into symbolic expressions. A non-linearity score is used in the SR process to obtain equations leading to low-complexity implementation and improved energy efficiency at the radios.

To assess the energy efficiencies of the MLP and KAN models, we compute the presently disclosed non-linearity score for both models, which is determined to be 6.84648×10⁵ and 1.2366×10⁶ for the KAN-based AE and the MLP-based AE, respectively. KANs are a viable alternative to MLPs for machine-learning based channel coding because the MLP-based model consumes 1.38 times more energy than the SR model.

KANs with symbolic regression offer a solution by simplifying learned models into simple math expressions. This may reduce computational demand and lead to lower energy consumption during operation. KANs can play a role in preserving battery life and maintaining performance. The presently described method helps to improve energy efficiency as compared to traditional MLP-based implementations of autoencoders for channel coding. Said method has the opportunity to model complex wireless communications channel behavior while preserving performance and consuming less energy.

In one exemplary embodiment disclosed herewith, a system and method for an end-to-end orthogonal frequency-division multiplexing (OFDM) digital wireless communication system is described.

It is to be understood that the presently disclosed subject matter equally relates to associated and/or corresponding methodologies. One exemplary such method relates to methodology for operating an end-to-end orthogonal frequency-division multiplexing (OFDM) digital wireless communication system, comprising providing at least one respective OFDM transmitter and at least one respective OFDM receiver; integrating a Kolmogorov-Arnold network (KAN)-based autoencoder (AE) model with symbolic regression into the OFDM transmitter and OFDM receiver; completing offline training of the KAN-based AE model for the transmitter and receiver; and using the KAN-based AE trained model for conducting communications between the transmitter and receiver.

Another exemplary such method relates to methodology for operating an end-to-end digital wireless communication system, comprising providing at least one respective digital wireless transmitter and at least one respective digital wireless receiver; integrating a Kolmogorov-Arnold network (KAN)-based autoencoder (AE) model with symbolic regression into the transmitter and receiver for energy-efficient channel coding of the transmitter and receiver; and using the KAN-based AE model for conducting communications between the transmitter and receiver.

Other example aspects of the present disclosure are directed to systems, apparatus, tangible, non-transitory computer-readable media, user interfaces, memory devices, and electronic devices for digital wireless communications. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to an end-to-end orthogonal frequency-division multiplexing (OFDM) digital wireless communication system. Such system preferably comprises at least one respective OFDM transmitter and at least one respective OFDM receiver; a Kolmogorov-Arnold network (KAN)-based autoencoder (AE) machine-learning model trained to process data with symbolic regression as transmitted from the OFDM transmitter; and one or more processors; and one or more non-transitory computer-readable media that store instructions that, when executed by the one or more processors, cause the one or more processors to perform operations. Such operations preferably comprise using the KAN-based AE trained model for conducting communications between the transmitter and receiver.

The present disclosure is applicable to a variety of fields including, but not limited to, telecommunications, internet of things, mobile device manufacturing and 5G infrastructure.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates a block diagram representation of a Kolmogorov-Arnold network (KAN)-based autoencoder (AE) paired with an end-to-end orthogonal frequency-division multiplexing (OFDM) transmitter and receiver, for any arbitrary n channel uses and kbits, i.e., illustrating OFDM transmitter and receiver block diagrams with an (n, k) KAN-AE;

FIG. 2 illustrates an exemplary embodiment of an Algorithm 1 for the presently disclosed exemplary symbolic regression (SR) procedure for use in the presently disclosed subject matter;

FIG. 3 illustrates an exemplary embodiment of an Algorithm 2 for outlining an exemplary process of the presently disclosed subject matter, including for jointly training encoder and decoder features of presently disclosed subject matter, where for such exemplary process B is the batch size,

$${σ}_{max}^{2} and {σ}_{min}^{2}$$

are the noise scheduling range, and a is the learning rate;

FIG. 4 graphically illustrates block-error rate (BLER) performance for multi-layer perceptron (MLP)-based AEs and Kolmogorov-Arnold network (KAN)-based AEs compared to that of (24,12) Golay code under an additive white Gaussian noise (AWGN) channel;

FIG. 5 graphically illustrates block-error rate (BLER) performance for multi-layer perceptron (MLP)-based AEs and Kolmogorov-Arnold network (KAN)-based AEs compared to that of (24,12) Golay code under a flat-fading Rayleigh channel;

FIG. 6 graphically illustrates Graphics Processing Unit (GPU) power consumption over time of (24,12) channel coding scheme decoders, as processed by exemplary MLP-based AE, Golay MLD code, and SR-based AE; and

FIG. 7 illustrates a Table 1 showing a comparison between the MLP and SR-based AEs in terms of peak power consumption, total energy consumption, and a presently disclosed non-linearity score subject matter.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

As used herein, the term “or” is inclusive unless stated otherwise. For instance, if a computer requires A or B to be true in order to perform operation C, the case of both A and B being true will satisfy the condition necessary for C to occur. That is, “or” is inclusive of A, B, and A and B.

In general, the present disclosure is directed to Kolmogorov-Arnold network (KAN)-based autoencoders (AEs) with symbolic regression (SR) for orthogonal frequency-division multiplexing (OFDM) to achieve energy-efficient channel coding.

### II. Preliminaries and System Model

In this section, we discuss preliminaries on KAN and provide our system model on OFDM-based AE.

### A. Kolmogorov-Arnold Networks

The structure of KANs is inspired by the Kolmogorov-Arnold representation theorem, which establishes that any multi-variate continuous function can be expressed as the sum of multiple uni-variate continuous functions [13], i.e.,

$$f \{ {x}_{1} , {x}_{2} , … , {x}_{d} ) = {\sum }_{i = 0}^{2 d} {Φ}_{i} ( {\sum }_{j = 1}^{d} {ϕ}_{i , j} ( {x}_{j} ) ) , \qquad ( 1 )$$

where φ_{i,j}∈[0,1]→ [symbol] and Φᵢ: [symbol] → [symbol] . The authors of [7] generalize the inner and outer sums in (1) to accommodate an arbitrary number of layers L such that

$$KAN ( x ) = ( {Φ}^{( L )} ◦ {Φ}^{( L - 1 )} ◦ … ◦ {Φ}^{( 2 )} ◦ {Φ}^{( 1 )} ) ( x ) , \qquad ( 2 )$$

where Φ⁽ⁱ⁾, [symbol] ∈{1, . . . L}, contains learnable activation functions applied to edges, as discussed in detail in Section II-B. Here, an edge refers to a connection between an input and an output neuron and performs a transformation on the input. It is worth noting that, in MLPs, the edges are linear learnable transformations and non-linear activation functions are fixed.

In [7], the authors express (x) as a linear combination of B-splines and sigmoid linear unit (SiLU) activation function. The function φ(x) in KANs can then be formulated as

$$ϕ ( x ) = {w}_{b} \times SiLU ( x ) + {w}_{s} \times {\sum }_{i} [ {c}_{i} \times {B}_{i} ( x ) ] , \qquad ( 3 )$$

where Bᵢ(x) is the B-spline basis function including piecewise polynomials of degree p and is scaled by a learnable weight cᵢ. The parameters w_{b} and wₛ are also learnable. Each B-spline is defined on a specific grid interval, which is determined from observing the range of input samples.

### B. System Model

Consider a single-user communication link. Let r=k/n be the rate of this communication link, where k is the total number of information bits per message and n is the total number of channel uses. Also, let sₘ∈ [symbol] be the one-hot encoded (OHE) vector representation of the message m. The encoder network ∈(sₘ) maps sₘ to the vector sₑ∈ [symbol] , which is then converted to the real and imaginary components of sₜₓ∈ [symbol] with [symbol] [|sₜₓ|²]=1. We consider L_{enc} layers at the encoder, where do denotes the number of neurons in the lth layer. For an MLP-based neural network, we have

$${a}_{enc}^{( l )} = {σ}_{enc}^{( l )} ( {W}_{enc}^{( l )} {a}_{enc}^{( l - 1 )} + {b}_{enc}^{( l )} ) l = 1 , … , {L}_{enc} , \qquad ( 4 )$$

where

$${σ}_{enc}^{( l )}$$

is the element-wise non-linear activation function,

$${W}_{enc}^{( l )}$$

∈ [symbol] and

$${b}_{enc}^{( l )}$$

∈ [symbol] are the weight matrix and bias vector, respectively. We note that for both the MLP and KAN models,

$${a}_{enc}^{( 0 )} = {s}_{m} and {a}_{enc}^{( {L}_{enc} )} = {s}_{e} .$$

For a KAN-based neural network, we have

$${a}_{enc}^{( l )} = {Φ}_{enc}^{( l )} ( {a}_{enc}^{( l - 1 )} ) l = 1 , … , {L}_{enc} \\ {Φ}_{enc}^{( l )} ( {a}_{enc}^{( l - 1 )} ) = [ \begin{matrix}{ϕ}_{1 , 1}^{( l )} ( {a}_{1}^{( l - 1 )} ) & … & {ϕ}_{1 , {d}_{l - 1}}^{( l )} ( {a}_{{d}_{l - 1}}^{( l - 1 )} ) \\ ⋮ & ⋱ & ⋮ \\ {ϕ}_{{d}_{l} , 1}^{( l )} ( {a}_{1}^{( l - 1 )} ) & … & {ϕ}_{{d}_{l} , {d}_{l - 1}}^{( l )} ( {a}_{{d}_{l - 1}}^{( l - 1 )} )\end{matrix} ] , \qquad ( 5 )$$

where

$${Φ}_{enc}^{( l )}$$

∈ [symbol] ,

$${a}_{enc}^{( 0 )} = {s}_{m} \text{?} and \text{?} ( \cdot )$$

$$\text{?} \text{indicates text missing or illegible when filed}$$

is the activation function in the lth layer connecting the dₗ₋₁th input neuron to the dlth output neuron. In this disclosure, we use (3) for learning the activation functions during training for KAN.

After the encoding at the transmitter, the transmitted symbols stx propagate through a communication channel, where they are distorted by the channel and zero-mean symmetric complex additive white Gaussian noise (AWGN). Let h∈ [symbol] denote the channel coefficient. A received symbol sᵣₓ can then be expressed as

$${s}_{rx} = {hs}_{tx} + w , \qquad ( 6 )$$

for w˜ [symbol] (0, [symbol] ). Under an AWGN channel, we set h=1. For a flat-fading Rayleigh channel, we instead let h˜CN(0, ½). Then, sᵣₓ are equalized using a minimum mean-squared error (MMSE) equalizer with h and noise variance [symbol] which yields

$${\hat{s}}_{rx} = \frac{\text{?}}{{\vert h \vert}^{2} + \text{?}} ,$$

$$\text{?} \text{indicates text missing or illegible when filed}$$

where ŝᵣₓ is the estimated transmitted symbol after equalization. The real and imaginary components of ŝᵣₓ∈ [symbol] are converted to a vector s_{d}∈ [symbol] .

Let δ(s_{d}) denote the decoder network that maps s_{d} to a logits vector ŝₘ∈ [symbol] . For L_{dec} layers, the MLP-based decoder and the KAN-based decoder follow the structure of (4) and (5), respectively. For the decoder, we note that

$$\text{?} = \text{?}$$

$$\text{?} \text{indicates text missing or illegible when filed}$$

and

$$\text{?} = {\hat{s}}_{m} .$$

$$\text{?} \text{indicates text missing or illegible when filed}$$

The detected message \hat{m} can be expressed as

$$m = {arg max}_{{\hat{s}}_{m} ∈ {ℝ}^{{2}^{k}}} {\hat{s}}_{m} . \qquad ( 7 )$$

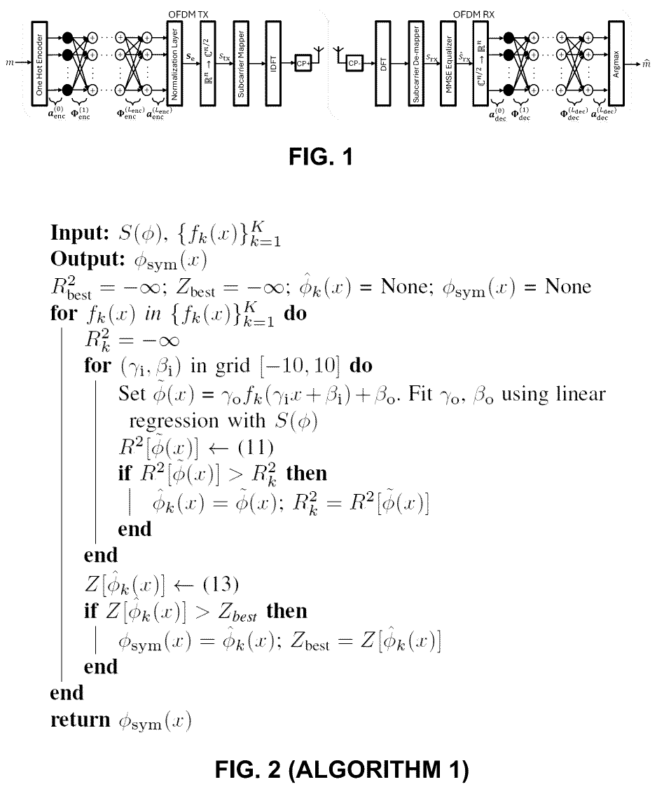

Traditional single layer neural networks, also called perceptrons, can only learn linear decision boundaries, which limits its ability to learn complex non-linear relationships. MLPs solve this issue using multiple layers; however, a single KAN layer can also model complex non-linear behaviors due to the non-linear activation functions on edges. FIG. 1 illustrates a block diagram representation of a Kolmogorov-Arnold network (KAN)-based autoencoder (AE) paired with an end-to-end orthogonal frequency-division multiplexing (OFDM) transmitter and receiver, for any arbitrary n channel uses and kbits. In other words, FIG. 1 illustrates OFDM transmitter and receiver block diagrams with an (n, k) KAN-AE. Here, we consider an arbitrary number of KAN layers at the transmitter and receiver; however, a single layer may be used in both cases.

### III. Energy-Efficient Kan-Based Autoencoder

In this disclosure, our ultimate goal is to reduce the number of learnable parameters at the encoder and decoder to maximize energy efficiency on both the transmitter and receiver while maintaining BLER as low as possible. To this end, we exploit that KANs are compatible with SR. Furthermore, we disclose a new penalty term in the SR process to discourage less energy-efficient symbolic expressions, where we heuristically score them by measuring function non-linearity, as discussed in Section III-A and Section III-B. This approach also allows us to score the energy efficiencies of MLP and KAN without making assumptions on their implementations, as discussed in Section III-C.

### A. Quantifying Function Non-Linearity

To quantify the degree of non-linearity for a function f(x) over an interval [a, b], we disclose to use a piecewise linear approximation. The underlying idea is to assess the nonlinearity of f(x) based on the minimum number of linear segments, N, required to approximate f(x) within a specified approximation error tolerance, E. The number of segments, i.e., N, serves as a metric of non-linearity; rather, a larger N indicates higher non-linearity, while a smaller N implies that f(x) is closer to a linear form over [a, b].

To express the aforementioned metric, consider a set of uniformly spaced partition points a₁, a₁, . . . , a_{N+1} for a₁=a and a_{N+1}=b, where [aⱼ, aⱼ₊₁) is the th sub-interval on which f(x) is linearly approximated. We express the approximation error over the/th sub-interval [aⱼ, aⱼ₊₁) as

$${e}_{j} = {\int }_{{a}_{j}}^{{a}_{j} + 1} {\vert f ( x ) - {ψ}_{j} ( x ) \vert}^{2} dx , \qquad ( 8 )$$

where ψⱼ(x)=mⱼx+kⱼ is the best-fit linear approximation of f(x) over [aⱼ, aⱼ₊₁). To obtain ψⱼ(x), we over-sample f(x) in jth sub-interval and use least squares linear regression, where mⱼ and kⱼ are the best-fit slope and intercept of the samples, respectively. We then measure the total approximation error across all sub-intervals as

$$E ( N ) = {\sum }_{j = 1}^{N} {e}_{j} . \qquad ( 9 )$$

We then define the non-linearity measure of f(x), i.e., Q[f(x)], as the smallest N that satisfies E(M)<∈, i.e.,

$$Q [ f ( x ) ] = arg {min}_{N} E ( N ) s . t . E ( N ) < ϵ . \qquad ( 10 )$$

If f(x) exhibits greater non-linearity, a larger N will be required to achieve the same approximation accuracy; conversely, if f(x) is more linear, a smaller Nis required. The metric for ([f(x)] is formulated within the context of SR. Nonlinear functions are often computationally intensive and energy-demanding. By determining Q[f (x)], we can estimate the energy cost of approximating f(x) and guide SR to favor simpler approximations where feasible.

Example 1: Let f(x)=[5x| and g(x)=sin(5x) be defined on the interval [−1, 1] and assume error tolerance ∈=10-3. For f(x) and g(x), compute E(N) using (9) and (8). Repeat this process and increase N each iteration until the condition in (9) is satisfied. Then, (10) is used to determine the score for each function. In this case the scores are Q[f(x)]=2 and Q[g(x)]=11. This is expected, as sin(5x) is far more oscillatory on [−1, 1] as compared to |5x], and should therefore be considered more non-linear.

### B. Symbolic Regression Under Non-Linearity Constraint

Consider an activation function φ(x)∈[a, b]→ [symbol] and a finite number of candidate functions

$${\{ {f}_{k} ( x ) \}}_{k = 1}^{K}$$

(e.g., sin, log, exp). Obtain samples S(φ)={φ(xᵢ)|xᵢ∈[a, b]}. Let \ddot{φ}(x)=γₒfₖ(ηx+βᵢ)+βₒ be an approximation of φ(x) given γᵢ, βᵢ, γₒ, βₒ, and f(x). For each \dot{φ}(x), we compute the R² score

$${R}^{2} [ \text{?} ( x ) ] = 1 - \frac{{\sum }_{i = 1}^{N} {[ ϕ ( {x}_{i} ) - \text{?} ( {x}_{i} ) ]}^{2}}{{\sum }_{i = 1}^{N} {[ ϕ ( {x}_{i} ) - \text{?} ( {x}_{i} ) ]}^{2}} , \qquad ( 11 )$$

$$\text{?} \text{indicates text missing or illegible when filed}$$

where \ddot{φ}(xᵢ)=E|φ(xᵢ)|. Next, we set

$${\hat{ϕ}}_{k} ( x ) = arg m \text{?} x {R}^{2} [ \text{?} ( x ) ] , \qquad ( 12 )$$

$$\text{?} \text{indicates text missing or illegible when filed}$$

where \dot{φ}ₖ(x) is the best approximation of φ(x) for a given fₖ(x). When determining the symbolic expression φ_{sym}(x) based on \hat{φ}ₖ(x), (10) and (11) are utilized in a combined score term Z[\hat{φ}ₖ(x)] for \hat{φ}ₖ(x), which is expressed as

$$Z [ {\hat{ϕ}}_{k} ( x ) ] = {R}^{2} [ {\hat{ϕ}}_{k} ( x ) ] + \frac{λ}{Q [ {\hat{ϕ}}_{k} ( x ) ]} , \qquad ( 13 )$$

where λ is a weight assigned to the non-linearity score term given in (10). Using the combined score in (13), we compute

$${ϕ}_{sym} ( x ) = arg m \text{?} x Z [ {\hat{ϕ}}_{k} ( x ) ] . \qquad ( 14 )$$

$$\text{?} \text{indicates text missing or illegible when filed}$$

In this disclosure, the parameters γᵢ and βᵢ maximizing R² for a given \hat{φ}(x) are determined using a grid search. Also, for each (γᵢ, βᵢ) pair, γo and βo are determined using least squares linear regression, where γₒ and βₒ are the best-fit slope and intercept of S(φ), respectively. The described approach is based on [7], with the presently disclosed non-linearity score term added to encourage energy-efficient equations when possible. FIG. 2 illustrates an exemplary embodiment of an Algorithm 1 (Convert φ(x) to symbolic expression) for the presently disclosed exemplary symbolic regression (SR) procedure for use in the presently disclosed subject matter.

### C. Scoring MLP and KAN Based on Non-Linearity Metric

Consider a generalized MLP-based neural network. The total score is a combination of the individual scores for linear and non-linear activations. So, the ([MLP(x)] is given by

$$Q [ MLP ( x ) ] = {\sum }_{l = 1}^{L} [ {d}_{l} \times ( {d}_{l - 1} + Q [ {σ}^{( l )} ( x ) ] ) ] , \qquad ( 15 )$$

where d₀ is the input size. Clearly, the choice of σ^{(l)} in each layer affects Q[MLP(x)].

Now, consider a KAN-based neural network, where each

$${ϕ}_{i , j}^{( l )}$$

is an activation function connecting the ith input to the jth output in the lth layer. The value of Q[KAN(x)] is determined by treating each learned activation function separately and computing each

$$Q [ {ϕ}_{i , j}^{( l )} ( x ) ]$$

using the methodology described in Section III-A. Here, we consider the derived symbolic expressions for

$${ϕ}_{i , j}^{( l )}$$

and not the original B-spline implementation. Summing the total score across all activation functions in the KAN-based network, we get

$$Q [ KAN ( x ) ] = {\sum }_{l = 1}^{L} {\sum }_{j = 1}^{{d}_{i}} {\sum }_{i = 1}^{{d}_{i - 1}} ( {a}_{i , j}^{( l )} \times Q [ {ϕ}_{i , j}^{( l )} ( x ) ] ) , \qquad ( 16 )$$

where

$${a}_{i , j}^{( l )}$$

is 0 if

$${ϕ}_{i , j}^{( l )}$$

is pruned and 1 otherwise. The network pruning process is described in Section III-D1. Note that, for KANs, the score for each

$${ϕ}_{i , j}^{( l )}$$

is evaluated on the grid interval of the activation function. For MLPs, the interval is chosen based on the domain, range, and boundedness of the activation function in each layer.

### D. Details for Further Improvements

1) Pruning: To further improve the energy efficiency of KANs further, we utilize the pruning methodology in [7].

For a KAN with multiple layers, each neurons importance is determined by incoming and outgoing scores

$${I}_{i}^{( l )} = {max}_{k} ( {‖ {ϕ}_{i , k}^{( l - 1 )} ( x ) ‖}_{1} ) , {O}_{i}^{( l )} = {max}_{j} [ {‖ {ϕ}_{j , i}^{( l + 1 )} ( x ) ‖}_{1} ) , \qquad ( 17 )$$

where

$${ϕ}_{i , k}^{( l - 1 )} ( x ) and {ϕ}_{j , i}^{( l + 1 )} ( x )$$

represent activation functions on edges to and from neuron i in layer l. Neurons with both scores above a threshold n are retained; conversely, all others are pruned. For KAN layers, we can also consider pruning individual activation functions on edges instead of neurons. In this case,

$${‖ {ϕ}_{i , k}^{( l - 1 )} ( x ) ‖}_{1}$$

is considered for all activation functions, and the edge is pruned if the value is below n. Pruning will help us to obtain more compact closed-form expressions; consequently, we improve the energy efficiency by removing redundant parts of each expression.

2) Training: To optimize BLER performance and preserve the energy efficiency of the KAN-based AE, we train the AE by using noise-scheduling along with a modified cross-entropy loss function

$$ℒ = - {\sum }_{i = 1}^{{2}^{k}} {T}_{i} log ( \frac{exp ( {l}_{i} )}{{\sum }_{j = 1}^{{2}^{k}} exp ( {l}_{j} )} ) , \qquad ( 18 )$$

where Tᵢ is the true label for the ith class, and lᵢ and lⱼ are the logits for the ith and jth decoder output. The model directly outputs logits since it does not have a softmax layer.

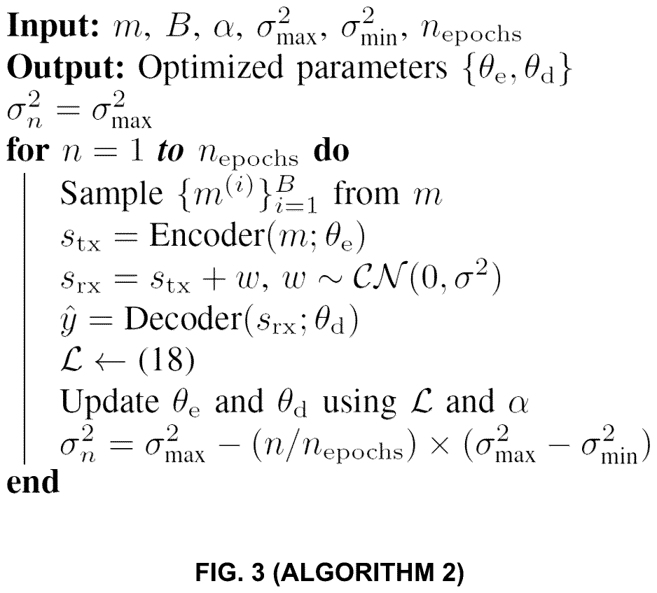

The Adam optimizer adjusts the encoder parameters θₑ and decoder parameters θ_{d} to jointly train the encoder and decoder. FIG. 3 illustrates an exemplary embodiment of an Algorithm 2 (AE training with noise scheduling) for outlining an exemplary process of the presently disclosed subject matter, including for jointly training encoder and decoder features of presently disclosed subject matter, where for such exemplary process B is the batch size, [symbol] are the noise scheduling range, and a is the learning rate.

### IV. Numerical Results

For numerical experiments, we consider a (24, 12) AE for an OFDM-based communication system. For comparison, we use MLP-based AEs with a single input, hidden, and output layer; specifically the hidden layer uses ReLU activation functions, while the output layer has no activation. In this disclosure, we consider an MLP with 150 hidden layers for both the encoder and decoder. The KAN-based AE replaces MLPs with a single KAN layer at both the encoder and decoder. Each activation function in the encoder and decoder contains 5 learnable control points c and third-degree polynomial basis functions. Since we want to avoid pruning key parts of each KAN-based model, we use η=10⁻⁵ at the encoder and η=3×10⁻⁵ at the decoder. For SR, we consider error tolerance ∈=10⁻² for the non-linearity score calculation described in Section III-A, and λ=3×10⁻² for the non-linearity score weight given in Section III-B.

The KAN-based AE and MLP-based AE are created, tested, and trained in Python using the PyTorch machine learning library. The ADAM optimizer is used to train each model for 3×10⁴ epochs, where each batch contains 2048 randomly selected m, and a learning rate of α=10⁻³. Here, E_{b}/N₀=6 dB is used to compute [symbol] and E_{b}/N₀=0 dB is used to compute

$${σ}_{min}^{2} .$$

The grid interval for the KAN activation functions is updated periodically to fit the training samples. All models are trained using a GeForce RTX 3070. We compare the MLP and KAN-based AEs to (24, 12) Golay code with maximum-likelihood decoding (MLD). Our implementation of MLD for Golay code utilizes quadrature phase shift keying (QPSK) as the modulation scheme, where [symbol] [|sₜₓ|²]=1. Let s_{g}∈ [symbol] contain ŝᵣₓ. We implement the MLD as

$$\hat{c} = arg {max}_{c} Re \{ {s}_{g}^{H} c \} , \qquad ( 19 )$$

where ĉ is the detected modulated codeword and c∈ [symbol] is a vector containing a QPSK modulated codeword for the Golay code. For this implementation, the number of linear operations in the decoder is n²×2^{k}, which we use to compute the nonlinearity score for (24, 12) Golay MLD. In this disclosure, n=24 channel uses and k=12 bits, so the non-linearity score for Golay MLD is 2.359296×10⁶.

### A. BLER Experiments

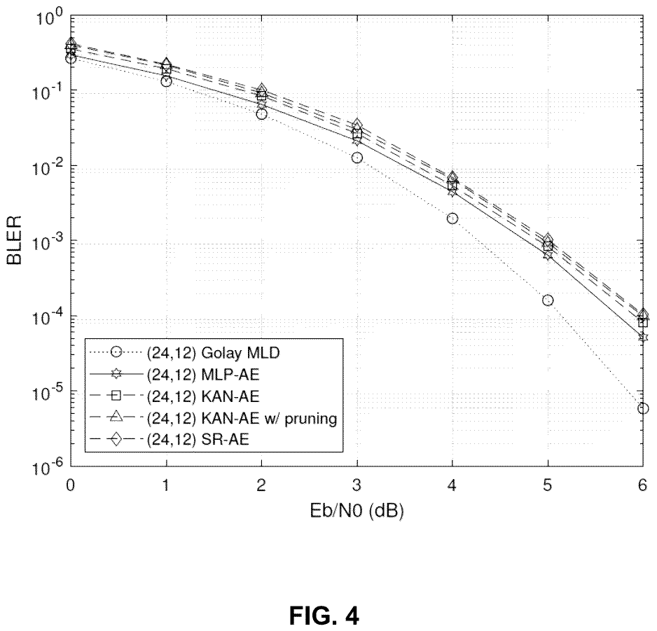

To characterize BLER performance, Monte-Carlo experiments are utilized. The BLER for MLP and KAN-based AEs is compared to that of(24, 12) Golay code under an AWGN channel. Specifically, FIG. 4 graphically illustrates block-error rate (BLER) performance for multi-layer perceptron (MLP)-based AEs and Kolmogorov-Arnold network (KAN)-based AEs compared to that of (24, 12) Golay code under an additive white Gaussian noise (AWGN) channel. The BLER curves in FIG. 4 show that the KAN-based AE performs similarly to the MLP-based AE and (24,12) Golay code in terms of BLER performance, with Golay slightly outperforming both. The KAN-based AE performs nearly identically to the MLP-based implementation. From FIG. 4, we see that pruning had a relatively minor effect on the overall BLER performance for KAN. Furthermore, the SR representation of KAN did not show degraded performance as compared to the pruned model.

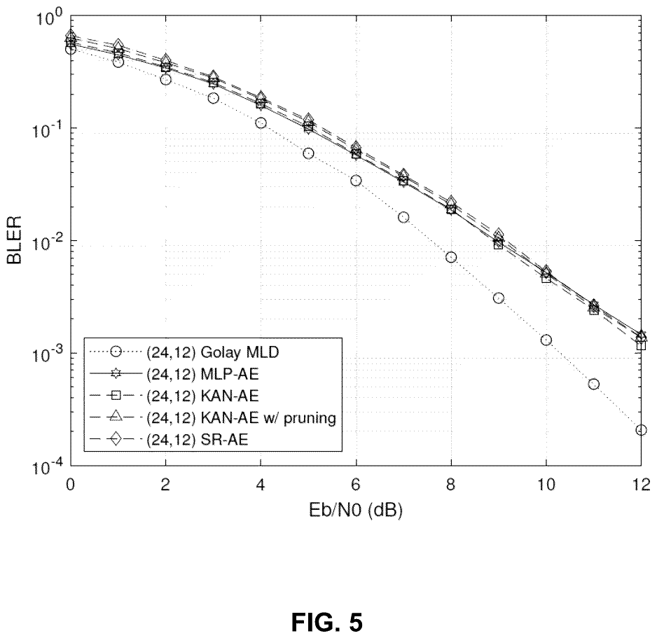

Another Monte-Carlo experiment compares the BLER for MLP and KAN-based AEs to that of (24, 12) Golay code under a flat-fading Rayleigh channel. Specifically, FIG. 5 graphically illustrates block-error rate (BLER) performance for multi-layer perceptron (MLP)-based AEs and Kolmogorov-Arnold network (KAN)-based AEs compared to that of (24,12) Golay code under a flat-fading Rayleigh channel. From FIG. 5, we can see that all models show similar performance. Like in the AWGN channel, we can see that pruning had a slight negative effect on BLER performance, with the SR representation showing nearly identical performance to the pruned model. The simulation results show that the SR-derived model performs very similarly to the original implementation, which indicates that the model accuracy is maintained.

### B. Power and Energy Consumption

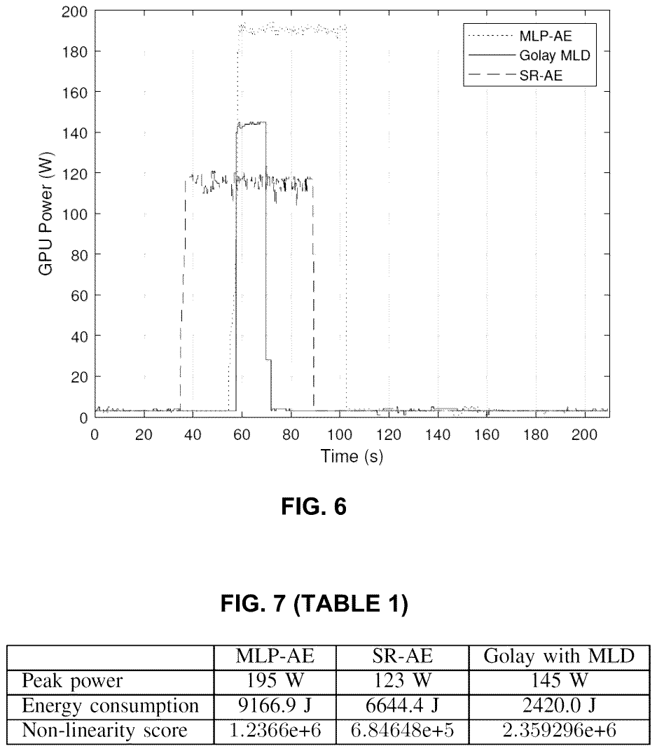

An experiment is conducted where 5,000 messages m are processed by the MLP-based AE, SR-based AE, and Golay code, for a fixed 25,000 trials. Specifically, FIG. 6 graphically illustrates Graphics Processing Unit (GPU) power consumption over time of (24,12) channel coding scheme decoders, as processed by exemplary MLP-based AE, Golay MLD code, and SR-based AE. The GPU power consumption during inference is monitored using NVIDIA FrameView for the MLP-based AE, Golay code, and SR-based AE. The energy consumption for each model is simply the area underneath the power consumption curve.

Therefore, a comparison of GPU power consumption over time for these decoders is seen in FIG. 6. It is worth emphasizing that since a NVIDIA RTX 3070 GPU is used in this experiment, the power draw is very large for all cases; however, in a practical system like a radio or mobile device, the power draw can be significantly reduced at the cost of evaluation speed. Furthermore, we emphasize that the curves seen in FIG. 6 are both implementation and hardware dependent. Regardless, we see that the MLP-based AE uses approximately 1.38 times more energy as compared to the SR-based AE. Here, we note that MLD for Golay code performs the best with respect to energy consumption, which can be explained by the hardware level optimizations of the PyTorch library, which is used to implement it.

FIG. 7 illustrates a Table 1 showing a comparison between the MLP and SR-based AEs in terms of peak power consumption, total energy consumption, and a presently disclosed non-linearity score subject matter. In particular, Table 1 (FIG. 7) shows comparisons between MLP-AE versus SR-AE versus Golay MLD. To assess the total score for the MLP-based AE, we consider the individual score for each ReLU activation function. ReLU is a piecewise linear function, where N=2; consequently, a score of 2 is assigned to each hidden layer activation. Furthermore, the output layer for both components of the AE have no activation, so the output layer activation function is assigned a score of 0. Then, using (15), we calculate the score seen in Table 1 (FIG. 7). Next, consider the KAN-based AE, which is pruned and converted to symbolic expressions. Each activation function is considered on its grid interval, which is [0, 1] for those in the encoder and [−2.2, 2.2] for those in the decoder. Using (16), we calculate the score seen in Table 1 (FIG. 7).

### V. Concluding Remarks

This disclosure demonstrates that KANs can provide advantages over MLP in terms of energy efficiency and model size for modulation and channel coding task. This is fundamentally due to the ability of KAN to convert activation functions into symbolic expressions, allowing for low-complexity inference by reducing the computational resources required during model operation. To achieve simpler symbolic expressions, in this disclosure, we disclose to score the non-linearity of symbolic expressions and eliminate unnecessary highly nonlinear activation functions during the SR procedure along with pruning. Our results show that KAN-based AEs performs similarly compared to MLP under both AWGN and flat-fading Rayleigh channels, all while achieving reduced energy consumption along with the presently disclosed SR method. This makes KANs a promising option for integrating deep learning models into energy-constrained devices in practical communication systems.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

### REFERENCES

[1] M. Soltani, V. Pourahmadi, A. Mirzaei, and H. Sheikhzadeh, “Deep learning-based channel estimation,” IEEE Communications Letters, vol. 23, no. 4, pp. 652-655, 2019.
[2] M. Zhang, Y. Zeng, Z. Han, and Y. Gong, “Automatic modulation recognition using deep learning architectures,” in Proc. IEEE International Workshop on Signal Processing Advances in Wireless Communications (SPAWC), 2018, pp. 1-5.
[3] A. Felix, S. Cammerer, S. Drner, J. Hoydis, and S. Ten Brink, “OFDM-autoencoder for end-to-end learning of communications systems,” in Proc. IEEE International Workshop on Signal Processing Advances in Wireless Communications (SPAWC), 2018, pp. 1-5.
[4] T. OShea and J. Hoydis, “An introduction to deep learning for the physical layer,” IEEE Transactions on Cognitive Communications and Networking, vol. 3, no. 4, pp. 563-575, 2017.
[5] Q. Mao, F. Hu, and Q. Hao, “Deep learning for intelligent wireless networks: A comprehensive survey,” IEEE Communications Surveys & Tutorials, vol. 20, no. 4, pp. 2595-2621, 2018.
[6] H. Huang, S. Guo, G. Gui, Z. Yang, J. Zhang, H. Sari, and F. Adachi, “Deep learning for physical-layer 5G wireless techniques: Opportunities, challenges and solutions,” IEEE Wireless Communications, vol. 27, no. 1, pp. 214-222, 2020.
[7] Z. Liu, Y. Wang, S. Vaidya, F. Ruehle, J. Halverson, M. Soljacic, T. Y. Hou, and M. Tegmark, “KAN: Kolmogorov-Arnold networks,” arXiv preprint arXiv:2404. 19756, 2024.
[8] R. Yu, W. Yu, and X. Wang, “KAN or MLP: A fairer comparison,” arXiv preprint arXiv:2407. 16674, 2024.
[9] Z. Liu, P. Ma, Y. Wang, W. Matusik, and M. Tegmark, “KAN 2.0: Kolmogorov-Arnold networks meet science,” 2024. [Online]. Available: https://arxiv.org/abs/2408.10205
[10] C. J. Vaca-Rubio, L. Blanco, R. Pereira, and M. Caus, “Kolmogorov-Arnold networks (KANs) for time series analysis,” arXiv preprint arXiv: 2405.08790, 2024.
[11] Z. Qin, H. Ye, G. Y. Li, and B.-H. F. Juang, “Deep learning in physical layer communications,” IEEE Wireless Communications, vol. 26, no. 2, pp. 93-99, 2019.
[12] D. Wu, M. Nekovee, and Y. Wang, “Deep learning-based autoencoder for m-user wireless interference channel physical layer design,” IEEE Access, vol. 8, pp. 174 679-174 691, 2020.
[13] A. K. Kolmogorov, “On the representation of continuous functions of several variables by superposition of continuous functions of one variable and addition,” Doklady Akademii Nauk SSSR, vol. 114, pp. 369-373, 1957.
[14] K. J. Geras and C. Sutton, “Scheduled denoising autoencoders,” arXiv preprint arXiv:1406.3269, 2014.

What is claimed is:

1. Methodology for operating an end-to-end orthogonal frequency-division multiplexing (OFDM) digital wireless communication system, comprising
providing at least one respective OFDM transmitter and at least one respective OFDM receiver;
integrating a Kolmogorov-Arnold network (KAN)-based autoencoder (AE) model with symbolic regression into the OFDM transmitter and OFDM receiver;
completing offline training of the KAN-based AE model for the transmitter and receiver; and
using the KAN-based AE trained model for conducting communications between the transmitter and receiver.

2. The methodology according to claim 1, further comprising using symbolic regression with the KAN-based AE to convert the KAN into symbolic expressions.

3. The methodology according to claim 2, wherein the symbolic expressions comprise equations representing the learned KAN-based AE model network behavior.

4. The methodology according to claim 3, further comprising scoring the non-linearity of the symbolic expressions and eliminating unnecessary highly nonlinear activation functions during the symbolic regression steps.

5. The methodology according to claim 4, further comprising using a continuous exchange of information between the transmitter and receiver to support adaptation to changing channel conditions, including conveying information related to current non-linearity scores.

6. The methodology according to claim 5, further comprising exchanging a pruning threshold used at the transmitter and receiver for pruning redundant activation functions of the KAN-based AE.

7. The methodology according to claim 3, wherein the KAN-based AE are described by activation function that can be formulated as equations of piecewise polynomials of degree p and learnable parameters and scaled by a learnable weight.

8. The methodology according to claim 1, wherein the transmitter and receiver operate with a plurality of channels and with a plurality of bits, and the Kolmogorov-Arnold network comprises at least one layer at each of the transmitter and receiver.

9. The methodology according to claim 8, further comprising a plurality of Kolmogorov-Arnold network layers at each of the transmitter and receiver.

10. The methodology according to claim 4, wherein scoring the non-linearity of an activation function of the KAN-based AE comprises quantifying the degree of non-linearity for an activation function over an interval of the function using piecewise linear approximation, based on the minimum number of linear segments required to approximate the activation function within a predetermined approximation error tolerance.

11. The methodology according to claim 10, wherein scoring non-linearity of a multi-layer implementation of a KAN-based neural network comprises obtaining a cumulative value for the network by determining scoring for each separate of learned activation function connects the jth input to the jth output in the Ath layer of the multi-layer network.

12. The methodology according to claim 11, further comprising pruning activation functions of the KAN-based AE based on a pruning threshold, wherein the pruning comprises for a multi-layer KAN-based AE determining the importance of each neuron of the neural network by calculating incoming and outgoing scores per activation functions on edges to and from each respective neuron in each layer, with neurons pruned which have scores at or below the pruning threshold.

13. An end-to-end orthogonal frequency-division multiplexing (OFDM) digital wireless communication system, comprising
at least one respective OFDM transmitter and at least one respective OFDM receiver;
a Kolmogorov-Arnold network (KAN)-based autoencoder (AE) machine-learning model trained to process data with symbolic regression as transmitted from the OFDM transmitter; and
one or more processors; and
one or more non-transitory computer-readable media that store instructions that, when executed by the one or more processors, cause the one or more processors to perform operations, the operations comprising:
using the KAN-based AE trained model for conducting communications between the transmitter and receiver.

14. The communication system according to claim 13, wherein the operations further comprise using symbolic regression with the KAN-based AE to convert the KAN into symbolic expressions.

15. The communication system according to claim 14, wherein the symbolic expressions comprise equations representing the learned KAN-based AE model network behavior.

16. The communication system according to claim 15, wherein the operations further comprise scoring the non-linearity of the symbolic expressions and eliminating unnecessary highly nonlinear activation functions during the symbolic regression steps.

17. The communication system according to claim 16, wherein the operations further comprise using a continuous exchange of information between the transmitter and receiver to support adaptation to changing channel conditions, including conveying information related to current non-linearity scores.

18. The communication system according to claim 17, wherein the operations further comprise exchanging a pruning threshold used at the transmitter and receiver for pruning redundant activation functions of the KAN-based AE.

19. The communication system according to claim 15, wherein the KAN-based AE are described by activation function that can be formulated as equations of piecewise polynomials of degree p and learnable parameters and scaled by a learnable weight.

20. The communication system according to claim 13, wherein the transmitter and receiver operate with a plurality of channels and with a plurality of bits, and the Kolmogorov-Arnold network comprises at least one layer at each of the transmitter and receiver.

21. The communication system according to claim 20, further comprising a plurality of Kolmogorov-Arnold network layers at each of the transmitter and receiver.

22. The communication system according to claim 16, wherein operations for scoring the non-linearity of an activation function of the KAN-based AE comprises quantifying the degree of non-linearity for an activation function over an interval of the function using piecewise linear approximation, based on the minimum number of linear segments required to approximate the activation function within a predetermined approximation error tolerance.

23. The communication system according to claim 22, wherein operations for scoring non-linearity of a multi-layer implementation of a KAN-based neural network comprises obtaining a cumulative value for the network by determining scoring for each separate of learned activation function connects the ith input to the th output in the Ath layer of the multi-layer network.

24. The communication system according to claim 23, wherein the operations further comprise pruning activation functions of the KAN-based AE based on a pruning threshold, wherein the pruning comprises for a multi-layer KAN-based AE determining the importance of each neuron of the neural network by calculating incoming and outgoing scores per activation functions on edges to and from each respective neuron in each layer, with neurons pruned which have scores at or below the pruning threshold.

25. Methodology for operating an end-to-end digital wireless communication system, comprising
providing at least one respective digital wireless transmitter and at least one respective digital wireless receiver;
integrating a Kolmogorov-Arnold network (KAN)-based autoencoder (AE) model with symbolic regression into the transmitter and receiver for energy-efficient channel coding of the transmitter and receiver; and
using the KAN-based AE model for conducting communications between the transmitter and receiver.

26. The methodology according to claim 25, wherein the at least one respective digital wireless transmitter and at least one respective digital wireless receiver are implemented using orthogonal frequency-division multiplexing (OFDM).

27. The methodology according to claim 25, further comprising:
completing offline training of the KAN-based AE model for the transmitter and receiver; and
using the KAN-based AE trained model for conducting communications between the transmitter and receiver.

28. The methodology according to claim 25, further comprising using symbolic regression with the KAN-based AE to convert the KAN into symbolic expressions comprising equations representing the learned KAN-based AE model network behavior.

29. The methodology according to claim 28, further comprising:
scoring the non-linearity of the symbolic expressions; and
using a continuous exchange of information between the transmitter and receiver to support adaptation to changing channel conditions, including conveying information related to current non-linearity scores.

30. The methodology according to claim 28, further comprising scoring the non-linearity of an activation function of the KAN-based AE by quantifying the degree of non-linearity for an activation function over an interval of the function using piecewise linear approximation, based on the minimum number of linear segments required to approximate the activation function within a predetermined approximation error tolerance.

31. The methodology according to claim 28, further comprising pruning activation functions of the KAN-based AE based on a pruning threshold, wherein the pruning comprises for a multi-layer KAN-based AE determining the importance of each neuron of the neural network by calculating incoming and outgoing scores per activation functions on edges to and from each respective neuron in each layer, with neurons pruned which have scores at or below the pruning threshold.
